(19) United States
(12) Patent Application Publication
(10) Pub. No.: US 2026/0347225 A1
(43) Pub. Date: Nov. 5, 2026

(54) ELECTROCHEMICAL-BIOLOGICAL CASCADE SYSTEMS AND METHODS FOR LOW-CARBON REMOVAL OF INORGANIC NITROGEN FROM WASTEWATER

(71) Applicant: University of Virginia Patent Foundation, Charlottesville, VA (US)

(72) Inventors: Lei Shi, Charlottesville, VA (US); Huiyuan Zhu, Charlottesville, VA (US)

(21) Appl. No.: 19/542,060

(22) Filed: Feb. 17, 2026

Related U.S. Application Data
(60) Provisional application No. 63/789,924, filed on Apr. 16, 2025.

(51) Int. Cl. C02F 3/00; C02F 3/28; C02F 3/30; C02F 101/16

(52) U.S. Cl. CPC C02F 3/006; C02F 3/2806; C02F 3/301; C02F 3/302; C02F 3/308; C02F 2101/16; C02F 2209/22; C02F 2209/40

(57) ABSTRACT

Disclosed herein is a wastewater treatment system, comprising (i) a biological treatment train comprising an anaerobic zone, a first oxic zone downstream of the anaerobic zone, and a secondary clarifier downstream of the first oxic zone, the secondary clarifier being configured to separate a mixed liquor into a clarified effluent and a settled biomass; and (ii) an integrated electrochemical-biological cascade disposed downstream of the secondary clarifier, the cascade comprising an electrochemical module configured to receive at least a portion of the clarified effluent and electrochemically reduce nitrate (NO₃⁻) in the clarified effluent to a mixture comprising nitrite (NO₂⁻) and ammonium (NH₄⁺) in controlled proportions; and an anammox module downstream of the electrochemical module and configured to convert, under anoxic conditions, at least a portion of the nitrite and ammonium to nitrogen gas (N₂).

### CROSS-REFERENCE TO RELATED APPLICATIONS

This application claims priority to U.S. non-provisional application 63/789,924 filed on Apr. 16, 2025, the entire contents of which are hereby incorporated by reference.

### STATEMENT OF GOVERNMENT INTEREST

This invention was made with government support under Award No. 2317302 awarded by the National Science Foundation. The government has certain rights in the invention.

### TECHNICAL FIELD

The present disclosure relates to wastewater treatment. More particularly, the disclosure relates to electrochemical conversion of nitrate to a controlled mixture of nitrite and ammonium coupled with anaerobic ammonium oxidation (anammox) for total inorganic nitrogen (TIN) polishing with reduced chemical consumption and greenhouse-gas emissions.

### BACKGROUND

Reactive nitrogen discharge from municipal wastewater contributes to eutrophication, harmful algal blooms, and degradation of drinking-water resources. Increasingly stringent nutrient regulations require wastewater treatment facilities to achieve low total inorganic nitrogen (TIN) in effluent, for example≤10 mg-N/L, while simultaneously reducing energy use, chemical inputs, and greenhouse-gas emissions. Nitrate (NO₃⁻) pollution in water bodies is an environmental problem that needs to be solved urgently. Excessive application of nitrogen fertilizers (such as ammonium nitrate and urea) as well as industrial wastewater and domestic discharges can lead to increased nitrate content in groundwater and surface water, causing environmental hazards such as eutrophication. Traditionally, biological denitrification processes are often used in sewage treatment to convert nitrate into nitrogen gas through microbial action under anoxic conditions.

FIG. 1A illustrates a conventional multi-stage biological wastewater treatment system 10 configured for biological nitrogen removal via nitrification and denitrification. The multi-stage biological wastewater treatment 10 system comprises a plurality of sequentially arranged biological treatment zones, each performing a distinct biochemical function. Wastewater influent is introduced into a series of treatment zones that are in sequential fluid communication including an anaerobic zone 12, a first anoxic zone 14 (an upstream anoxic zone 14), and a first oxic (aerobic) zone 16, followed by a second anoxic polishing zone 18 (a downstream anoxic zone 18) and a second (aerobic) oxic zone 20.

Mechanical mixing is provided in the anaerobic 12 and anoxic zones 14 to maintain solids suspension under substantially oxygen-depleted conditions, while aeration in the oxic zones 16 and 20 supplies dissolved oxygen to support aerobic microbial activity.

An external carbon source, such as methanol (MeOH), is introduced into the downstream anoxic zone 18 to promote heterotrophic denitrification, wherein nitrates produced during upstream nitrification is biologically reduced to nitrogen gas. Mixed liquor from the first oxic zone 16 is directed via an internal recycle loop back 28 to the first anoxic zone 14 to provide nitrate for denitrification. Following biological treatment, the mixed liquor flows to a secondary clarifier 22, where treated effluent is separated from biomass. Clarified water 21 is discharged as clean effluent, while settled biomass is split into return activated sludge 26, which is recycled to the head of the process, and waste activated sludge 24, which is removed from the system to maintain a “desired solids” residence time.

Despite its widespread use, the biological treatment configuration illustrated in FIG. 1A suffers from several technical and operational drawbacks. The process relies on energy-intensive aeration in oxic zones 16 and 20 to sustain nitrification, resulting in high electrical demand and operating costs. Effective denitrification in the downstream anoxic zone 18 further uses the continuous addition of an external organic carbon source, such as methanol, which increases chemical consumption, handling complexity, and safety risks.

FIG. 1B illustrates an alternative biological wastewater treatment configuration 30 in which the downstream anoxic zone 18 of FIG. 1A is replaced with an anammox (AMX) zone 19 to enable nitrogen removal. Wastewater influent is introduced sequentially into the anaerobic zone 12, the first anoxic zone 14, and the first oxic zone 16, followed by the AMX zone 19 and a second oxic zone 20. As in FIG. 1A, the anaerobic zone 12 and anoxic zone 14 are mixed under substantially oxygen-depleted conditions, while the oxic zones 16 and 20 are aerated to support aerobic biological oxidation and partial nitrification of ammonium to nitrite. Mixed liquor from the first oxic zone 16 is conveyed via an internal recycle loop to the upstream first anoxic zone 14 to provide oxidized nitrogen species as needed.

The AMX zone 19 contains anaerobic ammonium-oxidizing microorganisms configured to convert ammonium and nitrite directly to nitrogen gas without the need for an external organic carbon source. This pathway reduces overall oxygen demand and the use of methanol or other carbon dosing otherwise used for heterotrophic denitrification. Following nitrogen removal, the treated mixed liquor passes through the final oxic zone 20 to polish residual constituents before entering a secondary clarifier 22, where solids are separated from treated effluent. Clarified water 21 is discharged as clean effluent, while settled biomass is divided into return activated sludge 26, which is recycled to the head of the process, and waste activated sludge 22, which is withdrawn to control solids residence time.

The process depicted in FIG. 1B suffers from some of the same drawbacks as the process depicted in FIG. 1A. In addition, the staged nitrification-denitrification pathway can lead to the formation and release of nitrous oxide (N₂O), a greenhouse gas, particularly under transient loading or dissolved oxygen fluctuations. The need for internal mixed-liquor recycling to transport nitrate between zones introduces additional hydraulic and pumping energy constraints and complicates process control. Moreover, the multi-zone configurations in FIGS. 1A and 1B occupy a relatively large footprint, exhibit sensitivity to influent variability, and may demonstrate reduced nitrogen removal efficiency at low carbon-to-nitrogen ratios or low temperatures. Collectively, these limitations constrain the energy efficiency, environmental performance, and operational robustness of conventional biological nitrogen removal systems.

Accordingly, there remains a need for wastewater treatment modules and control strategies that (i) reliably generate nitrite in a controlled manner without external carbon addition, (ii) accommodate variable loads, and (iii) achieve low-TIN effluent with reduced greenhouse-gas emissions and improved operating economics.

### SUMMARY

Disclosed herein is a wastewater treatment system, comprising (i) a biological treatment train comprising an anaerobic zone, a first oxic zone downstream of the anaerobic zone, and a secondary clarifier downstream of the first oxic zone, the secondary clarifier being configured to separate a mixed liquor into a clarified effluent and a settled biomass; and (ii) an integrated electrochemical-biological cascade disposed downstream of the secondary clarifier, the cascade comprising an electrochemical module configured to receive at least a portion of the clarified effluent and electrochemically reduce nitrate (NO₃⁻) in the clarified effluent to a mixture comprising nitrite (NO₂⁻) and ammonium (NH₄⁺) in controlled proportions; and an anammox module downstream of the electrochemical module and configured to convert, under anoxic conditions, at least a portion of the nitrite and ammonium to nitrogen gas (N₂).

Disclosed herein is a method of treating wastewater, comprising conveying a clarified effluent from a secondary clarifier to an electrochemical module; electrochemically reducing nitrate in the clarified effluent within the electrochemical module to form nitrite and ammonium in controlled proportions; conveying an effluent of the electrochemical module comprising the nitrite and ammonium to an anammox module; and converting, under anoxic conditions in the anammox module, at least a portion of the nitrite and ammonium to nitrogen gas.

Disclosed herein is a method of manufacturing an electrochemical electrode for wastewater nitrate reduction, comprising depositing a metal nanowire catalyst onto a conductive porous substrate to form a cathode, wherein the metal nanowire catalyst comprises copper nanowires having an average diameter of from about 10 nm to about 100 nm and an average length of greater than about 1 μm; and assembling the cathode into an electrolysis cell of an electrochemical module configured to partially reduce nitrate in clarified wastewater to a mixture comprising nitrite and ammonium.

### BRIEF DESCRIPTION OF THE FIGURES

FIG. 1A illustrates a conventional multi-stage biological wastewater treatment system configured for biological nitrogen removal via nitrification and denitrification;

FIG. 1B illustrates an alternative biological wastewater treatment system in which the downstream anoxic zone of FIG. 1A is replaced with an anammox (AMX) zone to enable nitrogen removal;

FIG. 2 illustrates an exemplary electrochemically enhanced partial denitrification-anammox process scheme;

FIGS. 3A and 3B are graphs that depicts the electrocatalytic performance of Cu NWs in simulated wastewater;

FIG. 4 is a graph that depicts electrocatalytic performance of Cu NWs in simulated wastewater;

FIGS. 5A, 5B and 5C are graphs that depict electrocatalytic performance of Cu NWs in simulated wastewater;

FIGS. 6A, 6B and 6C are graphs that depict electrocatalytic performance of Cu NWs in simulated wastewater;

FIGS. 7A, 7B and 7C are graphs that depict electrocatalytic performance of Cu NWs in simulated wastewater;

FIGS. 8A and 8B are graphs that depict electrocatalytic performance of Cu NWs in municipal wastewater;

FIGS. 9A and 9B are graphs that depict electrocatalytic performance of Cu NWs in municipal wastewater; and

FIG. 10 is a graph that depicts economic sensitivity analysis of an ePdNA wastewater treatment process.

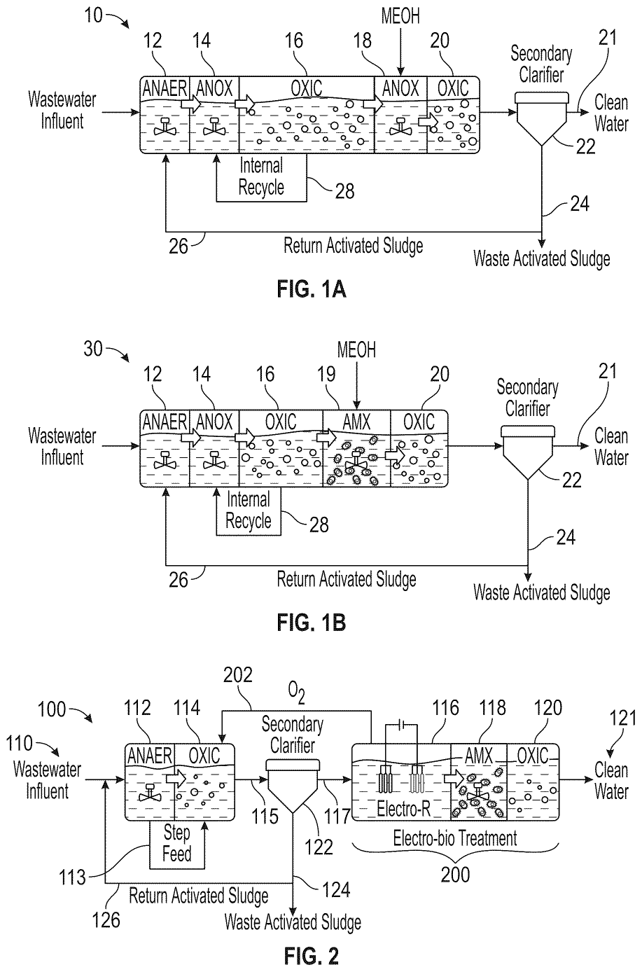

### DETAILED DESCRIPTION

Disclosed herein is an electrochemical-biological cascade (also referred to herein as electrochemically driven partial denitrification-anammox, “ePdNA”) that integrates an electrochemical reactor configured to reduce nitrate (NO₃⁻) to a controlled mixture of nitrite (NO₂⁻) and ammonium (NH₄⁺) and an anammox bioreactor configured to convert at least a portion of the nitrite and ammonium to nitrogen (N₂) under anoxic conditions. In certain embodiments, the electrochemical reactor includes a cathode comprising metal nanowires supported on a conductive substrate (e.g., carbon paper) and is operated under a controlled potential or controlled waveform to generate a target a nitrite-to-ammonium ratio, optionally about 1:1 on a N-basis, suitable for downstream anammox conversion. The cascade may be positioned as a tertiary polishing module downstream of secondary clarification and may optionally recycle anode-generated oxygen upstream to reduce aeration demand.

In some embodiments, the cascade employs feedback control based on real-time or periodic measurements of nitrate, nitrite, ammonium, pH, oxidation-reduction potential (ORP), conductivity, current, or other parameters, enabling load-responsive control and stable performance in real municipal wastewater matrices. In certain embodiments, the disclosed systems and methods achieve low-TIN effluent (e.g., ≤10 mg-N/L) without external organic carbon addition, with negligible N₂O emissions, and with reduced greenhouse-gas emissions and/or operating costs compared to NdN and/or biological PdNA.

FIG. 2 is a schematic illustration of an exemplary biological wastewater treatment system 100 that comprises an anerobic zone 112 (configured to receive wastewater influent 110) that lies upstream of a first oxic zone 114 and is in fluid communication with the first oxic zone 114. The first oxic zone 114 lies upstream of a secondary clarifier 122 that facilitates solid-liquid separation. A mixed liquor from the first oxic zone 114 is conveyed via line 115 to the secondary clarifier 122, where the solid-liquid separation occurs. Clarified effluent (the liquid) is discharged via line 117 as treated wastewater to an electrochemical module 116, while settled biomass (the solid) is divided into return activated sludge transported via line 126, which is recycled upstream to the anaerobic zone 112 (in a mixture with the wastewater influent), and waste activated sludge, which is withdrawn from the system 100 via line 124 to control the residence time of solids in the system.

Disposed downstream of the secondary clarifier 122 is an integrated wastewater treatment system 200 that comprises an electrochemical module 116, an anammox module 118 and a second oxic zone 120. The electrochemical module 116 lies upstream of the anammox module 118 and is in fluid communication with it. The anammox module 118 lies upstream of the second oxic zone 120 and is in fluid communication with the second oxic zone 120.

In an embodiment, the electrochemical module 116 receives an influent (the liquid wastewater from the secondary clarifier 122) comprising a nitrate. The electrochemical module 116 is configured to partially reduce nitrate to form nitrite and ammonium in controlled proportions, rather than fully reducing nitrate to ammonium. The effluent of the electrochemical module 116, comprising nitrite and ammonium, is provided to an anammox reactor 118 where anammox microorganisms convert nitrite and ammonium to nitrogen gas under anoxic conditions. In an embodiment, the second oxic zone 120 disposed downstream of the anammox (AMX) reactor 118 functions as a polishing and stabilization stage for the treated wastewater. Clean water 121 is released from the second oxic zone 120.

Each of the components of the biological wastewater treatment system 100 will now be described in detail. The anerobic zone 112 receives a wastewater influent 110 which can comprise municipal waste and agricultural waste. As used herein, wastewater influent refers to a liquid stream introduced into a treatment system that contains a mixture of water and dissolved and suspended constituents originating from municipal, industrial, agricultural, commercial, or mixed sources. The wastewater influent may comprise nitrogen-containing compounds, including ammonium, organic nitrogen, nitrite, and nitrate, as well as organic matter, suspended solids, dissolved salts, microorganisms, trace contaminants, and variable concentrations of oxygen. The influent may further include biodegradable and non-biodegradable organic compounds, nutrients, metals, sulfides, and other reduced or oxidized species, with composition and loading rates that vary temporally. Prior to treatment, the wastewater influent may exhibit elevated biochemical oxygen demand (BOD), chemical oxygen demand (COD), turbidity, and nutrient concentrations, and is introduced into the biological wastewater treatment system 100 for conditioning, biological conversion, and removal of contaminants to produce a treated effluent suitable for discharge, reuse, or further polishing.

The anaerobic zone 112 is configured to receive wastewater influent that may be pre-conditioned prior to biological processing in the wastewater treatment system 100. Recycled activated sludge via line 126 may also be mixed with the wastewater influent 110 and charged to the anaerobic zone. The weight ratio of the activated sludge via line 126 to the wastewater influent 110 is 1:4 to 1:1, preferably 1:3 to 1:2.

The anaerobic zone is maintained under substantially oxygen-free conditions and is configured to accommodate influent having altered oxidation-reduction potential (ORP), dissolved gas content, pH, alkalinity, and reactive species resulting from upstream electrolysis. The anaerobic zone contains a mixed liquor comprising suspended biomass, return activated sludge via line 126, and anaerobic and facultative microorganisms adapted to low-redox environments. Mechanical mixing is provided to maintain solids in suspension while avoiding oxygen introduction, and the zone is substantially devoid of aeration equipment. Any oxidizing species introduced into the anerobic zone are rapidly consumed or buffered within the anaerobic zone, thereby establishing stable anaerobic conditions suitable for downstream biological nitrogen removal.

Within the anaerobic zone, fermentative and facultative microorganisms metabolize readily biodegradable organic matter and electrochemically transformed substrates, thereby moderating influent variability and stabilizing microbial activity. The anaerobic zone further promotes conversion of organic nitrogen species to ammonium and equalization of influent chemistry prior to introduction into downstream anammox and oxic zones.

The principal microorganisms active in the anaerobic zone include hydrolytic and fermentative bacteria adapted to convert electrochemically conditioned influent organics into low-molecular-weight intermediates such as volatile fatty acids (VFAs), acetate, hydrogen, and carbon dioxide. Representative organisms include obligate and facultative anaerobes capable of utilizing fragmented chemical oxygen demand (COD) generated by the electrochemical module. In contrast to conventional anaerobic digesters, methanogenic archaea are suppressed or kinetically limited in FIG. 2, thereby favoring retention of ammonium, nitrite precursors, and reduced carbon species for downstream nitrogen removal rather than methane production.

Chemical oxygen demand (COD) is a measure of how much oxygen is needed to chemically oxidize all the organic (and some inorganic) material in a water or wastewater sample. In simple terms, it indicates how “dirty” the water is in terms of oxidizable matter.

In an embodiment, the anaerobic microbial population is selected to be electrochemically tolerant, such that exposure to transient hydrogen, altered redox states, or electro-generated intermediates does not disrupt biological function. As a result, the anaerobic chamber acts as a biological buffer and biochemical conditioning stage, converting electrochemically treated wastewater into a form optimized for high-efficiency nitrogen removal in the AMX reactor, prior to final polishing in the downstream oxic zone (the second oxic zone) where residual ammonia, COD, and dissolved gases may be further treated.

By decoupling electrochemical reactions from oxygen-sensitive biological processes, the anaerobic zone improves process robustness, protects anaerobic ammonium-oxidizing microorganisms from oxidative stress, and enables seamless integration of electrochemical pretreatment with biological nitrogen removal. The anaerobic zone thus functions as a compatibility interface that harmonizes influent with subsequent anaerobic and aerobic biological treatment stages.

In an embodiment, the first oxic zone 114 receives conditioned wastewater from the upstream anaerobic zone and functions as a controlled aerobic conversion stage that initiates nitrogen transformation and stabilizes influent chemistry prior to downstream treatment. A step feed line 113 that is in fluid communication with the anerobic zone 112 and the oxic zone 114 is configured to introduce a controlled fraction of influent wastewater at an intermediate location within the biological treatment train, rather than delivering the entire influent exclusively to the head of the system. This staged introduction of influent redistributes chemical oxygen demand (COD), nitrogen species, and hydraulic load along the reactor sequence, improving overall process stability and treatment efficiency.

Upon entry into the oxic zone 114, the wastewater contains ammonium, reduced nitrogen species, residual organic matter, and fermentation products generated in the anaerobic zone. The oxic zone is aerated to maintain a dissolved oxygen concentration sufficient to support ammonia-oxidizing microorganisms, which oxidize ammonium to nitrate. Concurrently, aerobic heterotrophic microorganisms oxidize residual biodegradable organic compounds, thereby reducing biochemical oxygen demand and minimizing competition for nitrite in downstream nitrogen-removal processes.

In addition, the first oxic zone serves to re-oxygenate and chemically stabilize the anaerobically conditioned influent, consume reduced intermediates, and equalize fluctuations in pH, alkalinity, and redox potential prior to transfer to downstream reactors. Aeration intensity and hydraulic residence time are selectively controlled to promote nitritation rather than full nitrification, enabling the production of nitrite in a form readily consumable by downstream anammox microorganisms. By converting anaerobically released nitrogen species into controlled oxidized intermediates, the first oxic zone prepares the wastewater for efficient nitrogen removal while limiting oxygen demand and preventing excessive nitrate formation.

In an embodiment, the secondary clarifier 122 receives mixed liquor from the first oxic zone 114 and functions as a solids-liquid separation unit to produce clarified effluent and concentrated biomass. The influent to the secondary clarifier comprises treated wastewater containing suspended biological solids, including aerobic and facultative microorganisms that have participated in nitrogen and organic matter conversion within the anerobic and oxic zones. Within the secondary clarifier, hydraulic conditions are controlled to promote gravitational settling of the suspended biomass, forming a settled sludge layer and an overlying clarified liquid phase. The clarified liquid, having reduced turbidity and suspended solids content, is withdrawn from the upper portion of the clarifier and discharged as treated effluent or conveyed to the integrated wastewater treatment system 200 that comprises an electrochemical module 116, an anammox module 118 and a second oxic zone 120.

As used herein, “secondary clarifier” refers to a gravity-based solid-liquid separation unit configured to receive biologically treated mixed liquor and to separate suspended microbial biomass from clarified effluent. The secondary clarifier may include a settling basin having a quiescent zone, a sludge collection mechanism, and one or more conduits configured to withdraw settled biomass as return activated sludge (RAS) and/or waste activated sludge (WAS). In some embodiments, the secondary clarifier is configured to maintain a sludge blanket and to control solids retention time (SRT) within the biological treatment stage. The clarified effluent withdrawn from an upper region of the secondary clarifier may be directed to discharge, reuse, or to a downstream polishing unit. The term “secondary” denotes that the clarifier receives effluent from a biological treatment stage, regardless of whether upstream treatment includes primary clarification, electrochemical pretreatment, or other preliminary processes.

The settled biomass collected in the lower portion of the secondary clarifier 122 is divided into return activated sludge, which is recycled upstream to the anerobic zone 126 maintain an active microbial population in the anaerobic and oxic zones, and waste activated sludge, which is removed from the system to regulate solids residence time and prevent excessive biomass accumulation. The secondary clarifier 122 is therefore in a recycle loop with the anerobic zone 112. By separating biomass from treated water, the secondary clarifier stabilizes effluent quality, decouples biological reaction conditions from hydraulic throughput, and enables independent control of microbial inventory and hydraulic loading. The secondary clarifier 122 thus serves as a useful interface between biological treatment in the oxic zone and final effluent discharge.

In an embodiment, the electrochemical module 116 receives clarified effluent from the secondary clarifier 122 and functions as a post-clarification conditioning stage. The influent to the electrochemical module comprises treated wastewater having substantially reduced suspended solids content and a stabilized hydraulic profile, which is particularly suitable for electrochemical processing. In an embodiment, the suspended solids content of the clarified effluent received at the electrochemical module 116 is at least 25 wt % less, preferably at least 35 wt % less and more preferably at least 50 wt % less than that received initially at the anerobic zone 112.

Within the electrochemical module 116, the clarified effluent is exposed to an electrolysis cell comprising an anode and a cathode that are energized to induce controlled electrochemical reactions within the liquid phase. Operation of the electrochemical module may generate oxidizing and reducing species, adjust oxidation-reduction potential, and modify dissolved gas concentrations, including the generation of oxygen at the anode and hydrogen at the cathode. These electrochemically generated species may further oxidize residual reduced nitrogen species, organic micropollutants, sulfides, or other trace constituents remaining after biological treatment.

In some embodiments, the electrochemical module 116 comprises an electrolysis cell including a cathode and an anode separated by a membrane (e.g., cation exchange membrane, anion exchange membrane, or bipolar membrane), or alternatively an undivided cell.

In certain embodiments, the cathode comprises metal nanowires deposited on a conductive porous substrate (e.g., carbon paper, carbon cloth, graphite felt, carbon aerogels, carbon nanotubes, metal mesh, or a combination thereof). The metal nanowires may have diameters in the nanoscale range (e.g., 10 to 100 nanometers) and lengths in the micrometer range (e.g., greater than 1 micrometers, preferably greater than 5 micrometers, and more preferably greater than 10 micrometers).

Suitable metals include, but are not limited to, noble metals such as gold, silver, platinum, palladium, rhodium, iridium, and ruthenium; coinage and post-transition metals such as copper, aluminum, gallium, indium, tin, lead, and bismuth; transition metals such as nickel, cobalt, iron, chromium, manganese, molybdenum, tungsten, vanadium, titanium, and zirconium, or the like, or a combination thereof.

In other embodiments, the cathode may include a cathode catalyst that comprises bismuth nanoparticles or other electrocatalysts capable of selectively converting nitrate to nitrite and ammonium in dilute wastewater matrices.

In an embodiment, the electrochemical module 116 may serve as an active resource-generation and integration unit for the treatment system. Oxygen generated at the anode may be recovered and directed upstream via line 202 to supply all or a portion of the oxygen demand of one or more oxic biological zones, thereby reducing mechanical aeration demand. Hydrogen generated at the cathode may be vented, captured, or utilized as an energy carrier or electron donor in other treatment processes. By receiving clarified effluent from the secondary clarifier, the electrochemical module operates with reduced electrode fouling, improved energy efficiency, and enhanced process control. The electrochemical module thus functions to further improve effluent quality while simultaneously enabling energy and resource recovery within the overall wastewater treatment system.

In some embodiments, the electrochemical module is operated under potentiostatic or galvanostatic control relative to a defined reference electrode, such as a reversible hydrogen electrode (RHE) or other suitable reference. The applied potential may be selected from a first potential range in which electrochemical nitrate reduction preferentially yields nitrite as a dominant product, and from a second, more cathodic potential range in which further reduction reactions are promoted such that formation of ammonium is increased. By selectively operating within one or more of these potential ranges, the electrochemical module may be configured to tune nitrogen speciation in the treated effluent, for example to favor partial nitrate reduction to nitrite for downstream biological or catalytic processing, or to promote deeper reduction toward ammonium when desired.

In some embodiments, the electrochemical module is operated using a time-varying electrical input, such as a pulsed or waveform-controlled potential or current. The waveform may comprise alternating cathodic and anodic pulses, square waves, ramped profiles, or other periodic or aperiodic signals. In one exemplary embodiment, a cathodic pulse is applied to drive nitrate or nitrite reduction reactions at the cathode surface, while an anodic pulse is intermittently applied to oxidize adsorbed species, reconstruct the catalytic surface, or otherwise mitigate fouling, catalyst poisoning, scaling, or surface passivation associated with real municipal or industrial wastewater streams. Such pulsed operation may enhance long-term stability, maintain catalytic activity, and improve process robustness relative to steady-state operation.

In some embodiments, the system includes a controller (not shown) operatively coupled to the electrochemical module and configured to dynamically adjust one or more operating variables to maintain a target nitrite-to-ammonium ratio or other desired nitrogen speciation. The adjustable operating variables may include, without limitation, applied potential, current density, duty cycle, pulse frequency, or other waveform parameters; residence time of wastewater within the electrochemical module; influent or effluent flow rate; pH or alkalinity control; electrolyte conductivity management; and periodic or on-demand regeneration steps. The controller may utilize sensor feedback, model-based control, preset operating profiles, or combinations thereof to adapt system operation in response to influent variability, catalyst condition, or downstream process requirements.

Located downstream of the electrolytic module 116 is the anammox zone 118. In some embodiments, the anammox zone 118 is configured according to any anammox-supporting biological treatment architecture suitable for sustaining anaerobic ammonium-oxidizing microorganisms. Such configurations may include suspended-growth systems, attached-growth systems, granular sludge reactors, moving bed biofilm reactors (MBBR), integrated fixed-film activated sludge (IFAS) systems, or combinations thereof. The selected configuration may be tailored to promote biomass retention, enhance mass transfer, improve process stability, and accommodate variable nitrogen loading conditions while maintaining an anaerobic or substantially anoxic environment conducive to anammox metabolism.

In some embodiments, the anammox zone 118 (also referred to as the AMX zone 118) is operated with a feed stream comprising nitrite and ammonium supplied in a controlled ratio that is approximately stoichiometric for anammox biochemical conversion. In one exemplary embodiment, the molar or mass-normalized nitrogen ratio of nitrite-nitrogen to ammonium-nitrogen is controlled to about 1:1, optionally within ±20% of stoichiometry. Maintaining the feed within this range may promote stable conversion of reactive nitrogen species to dinitrogen gas (N₂), minimize accumulation of residual nitrite, nitrate, or ammonium, and improve overall nitrogen removal efficiency.

In some embodiments, the anammox zone 118 is supplied with micronutrients or trace elements effective to enhance microbial activity, growth, or long-term stability of the anammox biomass. Such micronutrients may include, by way of example and not limitation, iron, copper, zinc, cobalt, molybdenum, nickel, selenium, vitamins, or combinations thereof, provided in dissolved, chelated, or solid-supported form. The micronutrients may be dosed continuously, intermittently, or in response to monitored process conditions to support enzymatic function, maintain metabolic activity, and mitigate performance degradation over extended operating periods.

The second oxic zone 120 (which lies downstream of the anammox zone 118) is supplied with dissolved oxygen and is configured to oxidize residual ammonium, nitrite, and reduced nitrogen species that may remain following anammox treatment. In addition, the second oxic zone 120 supports aerobic microorganisms that oxidize residual biodegradable organic matter and convert reduced intermediates to more stable forms, thereby improving effluent clarity and chemical stability. The second oxic zone 120 further serves to re-oxygenate the mixed liquor, strip dissolved nitrogen gas produced in the AMX reactor, and mitigate the release of reduced byproducts or odors. By providing controlled aerobic conditions downstream of the AMX zone, the second oxic zone ensures consistent effluent quality, regulatory compliance, and process robustness under variable influent loading conditions prior to discharge as treated water.

In certain embodiments, the electrochemical partial denitrification-anammox (ePdNA) module is deployed to fine-tune or finish the effluent so that it meets stringent discharge limits. In an embodiment (not shown), it is positioned downstream of secondary clarification within a Level-3 wastewater treatment train. In such configurations, the ePdNA module may replace or supplement conventional polishing denitrification zones, post-anoxic basins, or external carbon dosing steps typically used to achieve low total inorganic nitrogen (TIN) limits. By electrochemically generating a controlled nitrite-to-ammonium feed suitable for downstream anammox conversion, the ePdNA module may eliminate the need for multiple biological zones, internal recycle loops, or dedicated carbon feed systems (e.g., methanol, acetate, glycerol). In some embodiments, this integration reduces overall system footprint, simplifies hydraulic design, decreases pumping and recycle energy demands, and facilitates retrofit of existing treatment plants constrained by space, complexity, or operational cost.

In certain embodiments, the system is configured to achieve treated effluent that meets or exceeds regulatory discharge standards, including a total inorganic nitrogen (TIN) concentration of less than or equal to about 10 mg-N/L, while substantially reducing or eliminating the addition of external organic carbon. In some embodiments, the electrochemical control of nitrogen speciation upstream of the anammox reactor suppresses pathways associated with nitrous oxide (N₂O) formation, thereby reducing N₂O emissions relative to conventional nitrification-denitrification (NdN) processes. In further embodiments, overall greenhouse-gas emissions are reduced relative to NdN and/or biologically driven partial denitrification-anammox (PdNA) systems, particularly when the electrochemical module is powered by low-carbon or renewable electricity sources. Collectively, these performance outcomes may provide a lower-emissions, lower-energy, and operationally simplified pathway for advanced nitrogen removal in municipal and industrial wastewater treatment applications.

### EXAMPLE

This example was conducted to demonstrate the biological wastewater treatment system that uses an electrochemical partial denitrification-anammox (ePdNA) cascade to treat an effluent. In short, these experiments were conducted to determine the feasibility of an electrochemical-biological cascade for sustainable nitrogen removal from municipal wastewater.

### Chemicals Used

All chemicals were used as purchased without further purification. Deionized nanopure water (18.2 MΩ cm) obtained from Thermo Scientific Barnstead water purification systems was used for all experiments. Copper(I) chloride (CuCl, 99.9%), oleylamine (OAm, 70%), potassium hydroxide (KOH), phosphate-buffered saline (pH=7.4), potassium nitrate (KNO₃), sodium hypochlorite solution (NaClO, 10%), sodium citrate (C₆H₅Na₃O₇), salicylic acid (C₇H₆O₃), sodium nitroprusside (Na₂[Fe(CN)₅NO]·2H₂O), hydrogen peroxide (H₂O₂), sulfuric acid (H₂SO₄), bismuth neodecanoate, octadecene (ODE), tri-n-octylphosphine (TOP), 1-dodecanethiol (DDT) and Nafion solution (5 wt %) were purchased from Sigma-Aldrich. Potassium bicarbonate (NaHCO₃), magnesium sulfate heptahydrate (MgSO₄·7H₂O), calcium chloride dihydrate (CaCl₂·2H₂O), ethylenediaminetetraacetic acid (EDTA), zinc sulfate heptahydrate (ZnSO₄·7H₂O), Cobalt(II) chloride hexahydrate (CoCl₂·6H₂O), manganese chloride tetrahydrate (MnCl₂·4H₂O), copper(II) chloride (CuCl₂), sodium molybdate(VI) dihydrate (NaMoO₂·2H₂O), nickel(II) chloride hexahydrate (NiCl₂·6H₂O), sodium sulfate decahydrate (NaSeO₄·10H₂O), Boric acid (H₃BO₃) were purchased from Thermo Fisher Scientific. Hach TNT® test kits were purchased from Hach Company.

### Synthesis of Catalysts

### Copper Nanowires

Typically, cuprous chloride (2.0 mmol) was dissolved in oleylamine (6.0 mL), and the mixture was heated to 100 °C under an Ar flow. After degassing under reduced pressure for 20 minutes, the solution was rapidly heated to 195 °C under argon. The color of the solution changed from light yellow to slightly red within one minute. After 30 minutes, the heating source was removed, and the reaction mixture was cooled to room temperature. The precipitate was then collected by centrifugation at 3000 rpm for 5 min, washed three times with hexane and excess ethanol, and finally dispersed in hexane.

### Bismuth Nanoparticles

1 mmol of bismuth neodecanoate was mixed with 5 mL of ODE and heated to 120 °C for 2 h under a gentle N₂ flow, to remove dissolved moisture and oxygen. After that, the system was air-cooled to 80 °C, while 0.24 mL of DDT was injected into the solution to form Bi intermediate complex. After 5 minutes, 1.0 mL of TOP was added into the solution, and the system was further cooled to 60 °C and kept at this temperature for 30 minutes. After being cooled to room temperature, the Bi NPs were collected and washed by the addition of acetone (25 mL) and subsequent centrifugation at 9000 rpm for 8 minutes.

### Analytical Equipment

Powder X-ray diffraction (PXRD) patterns of samples were collected using a Malvern Panalytical Empyrean X-ray diffractometer (Cu Kα radiation, λ=1.5406 Å).

The size and morphology of the samples were characterized using a 120 kV Thermo Fisher Scientific Tecnai Spirit TEM. Bright-field TEM (BF-TEM), HAADF-STEM, and energy-dispersive X-ray spectroscopy (EDS) analyses were performed using a Thermo Fisher Scientific Talos F200X TEM equipped with a Super-X EDS detector.

The copper and bismuth content of the catalyst, as well as the potassium, calcium, magnesium, copper, and nickel content of the wastewater, were determined by inductively coupled plasma optical emission spectrometry on a SPECTRO GENESIS inductively coupled plasma spectrometer.

Ion chromatography (Metrohm Eco IC instrument) was used to determine the concentrations of remaining NO₃⁻ and generated NO₂⁻. NH₄⁺ concentration was quantified using a UV-visible spectrophotometer (Agilent 3500) coupled with indophenol blue spectrophotometry. The gas product was quantified by gas chromatography (Agilent 7890B).

Electrochemical Measurements of No₃⁻ Reduction Reaction

Electrochemical measurements were performed using a three-electrode system connected to a BioLogic electrochemical workstation. Platinum foil and Ag/AgCl (3.5 M KCl) served as the counter electrode and reference electrodes, respectively, while a carbon paper-supported catalyst was used as the working electrode. First, 1 mg of catalyst was dispersed in 980 μl of isopropanol, and 20 μl of Nafion solution (5 wt %, Sigma-Aldrich) was added. The mixture was then sonicated for at least 30 minutes to generate a uniform ink. Next, 200 μl of the dispersion was deposited onto a 1 cm² carbon paper sheet, resulting in a metal loading of approximately 0.2 mg cm⁻². All measurements were conducted at room temperature in an H-cell separated by an ion-exchange membrane (Nafion 117). The Nafion 117 membrane was pretreated for 1 hour in a 5% H₂O₂ solution at 80 °C, followed by a further 1-hour treatment in a 0.5 M H₂SO₄ solution at 80 °C. It was then rinsed several times with deionized water and stored in deionized water. All potentials in this study were referenced to Ag/AgCl (measured) or RHE. Potentials were converted to RHE using the equation E (RHE)=E(Ag/AgCl)+0.198 V+0.059×pH. The electrolytes used in this experiment were 0.01 M PBS+40 mg-N L⁻¹ NO₃⁻, 0.01 M PBS+120 mg-N L⁻¹ NO₃, 0.1 M KOH+40 mg-NL⁻¹ NO₃⁻, 0.1 M KOH+120 mg-NL⁻¹ NO₃⁻, and municipal wastewater. Real municipal wastewater was obtained from Pepper's Ferry Regional Wastewater Treatment Facility in Blacksburg, Virginia, USA. Prior to electrochemical measurements, degassing was performed by bubbling argon gas into the electrolyte for 30 minutes. All tests were performed in triplicate, and standard deviations were obtained.

Determination and Quantitation of NH₄⁺

Using the salicylic acid-hypochlorous acid indophenol reaction, with sodium nitroprusside as a catalyst, the concentration of NH₄⁺ in electrolytes was quantitatively determined by UV-visible detection at 655 nm. Specifically, solution A contained 0.5 M NaOH, 5 wt % sodium citrate, and 5 wt % salicylic acid. Solution B was a 0.05 M NaClO solution. Solution C was a 1 wt % sodium nitroprusside solution. After diluting the post-reaction electrolyte to an appropriate concentration, mix 2 mL of electrolyte, 2 mL of Solution A, 1 mL of Solution B, and 0.2 mL of Solution C. After standing at room temperature in the dark for 60 minutes, the absorbance of the solution was measured. Prepare solutions at different NH₄⁺ concentrations (0.5 mg-NL⁻¹, 1 mg-N L⁻¹, 2 mg-N L⁻¹, 4 mg-N L⁻¹, 6 mg-NL⁻¹, 8 mg-N L⁻¹) and plot a calibration curve. The NH₄⁺ concentration in the electrolyte was then determined using this calibration curve.

### In-Situ ATR-SEIRAS Experiments

Electrochemical in-situ ATR-SEIRAS experiments were performed in a single-chamber PEEK spectroelectrochemical cell equipped with a VeeMAXIII ATR accessory. A graphite rod was used as the counter electrode and saturated Ag/AgCl was used as the reference electrode. The potential was controlled by an Autolab potentiostat (PGSTAT204, Metrohm). Infrared measurements were performed on a Thermo Nicolet iS50 FTIR equipped with a liquid nitrogen-cooled MCT detector. An improved chemical deposition method was used to generate gold film electrodes on the reflective surface of a silicon ATR crystal prism cut at a 60° incident angle to enhance the signal. In-situ ATR-SEIRAS experiments were performed in 0.01 M PBS+120 mg-N L⁻¹ KNO₃, with an average of 64 scans at each potential.

### In-Situ Raman Measurements

In-situ Raman experiments were performed in a single-chamber PEEK spectroelectrochemical cell equipped with a quartz window and an inverted Raman microscope system. Raman measurements were performed using a 785 nm laser focused on the electrode/electrolyte interface through a long working distance objective (50×, NA≈0.5); to avoid photothermal effects, the laser power at the sample was <0.5 mW. A graphite rod was used as the counter electrode, saturated Ag/AgCl was used as the reference electrode, and the three-electrode system was controlled by an Autolab potentiostat. The experimental electrolyte was 0.1 M KOH, the spectral range was 200-700 cm⁻¹, and the nominal resolution was 2 cm⁻¹. All spectra were calibrated to the single-crystal silicon 520.7 cm⁻¹ peak before acquisition.

### Material Preparation of Anammox Test

The anammox bacteria seed was sourced from a 1-L fed-batch anammox reactor that had been operated for 270 days in an anaerobic glovebox. A 50 mL sample of the anammox biomass was centrifuged at 2,000×g for 15 minutes at 20 °C. The supernatant was discarded, and the resulting pellet was retained for subsequent experiments. Micronutrients contained (per L solution): NaHCO₃, 419 mg; KH₂PO₄, 20 mg; MgSO₄·7H₂O, 300 mg; CaCl₂·2H₂O, 100 mg; and 1 mL trace element solutions I and II. The solution I contained (per L demineralized water): EDTA, 5 g; FeSO₄·7H₂O, 2.732 g; and solution II contained (per L demineralized water): EDTA, 15 g; ZnSO₄·7H₂O, 0.430 g; CoCl₂·6H₂O, 0.240 g; MnCl₂·4H₂O, 0.990 g; CuCl₂, 0.135 g; NaMoO₂·2H₂O, 0.220 g; NiCl₂·6H₂O, 0.190 g; NaSeO₄·10H₂O, 0.210 g; H₃BO₃, 0.014 g.

### Anammox Test of Electrolyzed Simulated Wastewater

As previously described, using KOH or PBS as the electrolyte and Cu NWs as the electrode respectively, the solution containing 120 mg-N L⁻¹ of NO₃⁻ was converted to approximately equal amounts of NH₄⁺ and NO₂⁻. To test whether electrolysis of simulated wastewater produced any inhibitory compounds, anammox bacteria were inoculated with essential nutrients to monitor cell growth and substrate utilization, compared with a control consisting of simulated media only. Micronutrients were added to the two electrolysis-treated solutions (KOH and PBS groups) to create culturing media, while a control group of simulated wastewater without electrolysis was also prepared. This control group contains 50 mg-N L⁻¹ NH₄⁺ (from ammonium chloride) and 50 mg-N L⁻¹ NO₂⁻ (from sodium nitrite) along with micronutrients mentioned above. The pH of the three-culturing media (KOH, PBS, and control groups) was adjusted to 7.0-7.5. Then, the anammox biomass pellet was inoculated into 100 mL of the KOH, PBS, and control group media to start the incubation experiment. All media preparation and anammox incubation works were performed in an anaerobic glovebox at room temperature. 1 mL aqueous samples were collected at each time interval over three days to analyse NH₄⁺—N, NO₂⁻—N, and NO₃⁻—N concentrations. All experiments were conducted in triplicate.

### Anammox Test of Treated Real Municipal Wastewater

The municipal wastewater prepared by the electrolysis technique was also inoculated with anammox bacteria to test if any inhibitory compounds have formed. To this end, anammox biomass pellet was mixed with 100 mL of electrolyzed municipal wastewater with and without micronutrient supplementation to test whether micronutrient supplementation is necessary when municipal wastewater is used. The same inoculation was made in a 100 mL control made of DI water containing 10 mg-N L⁻¹ NH₄⁺ (from ammonium chloride) and 10 mg-N L⁻¹ NO₂⁻ (from sodium nitrite), along with micronutrients mentioned above. Again, all media preparation and anammox incubation works were performed in an anaerobic glovebox at room temperature. 1 mL aqueous samples were collected daily during the first six days and every other day from day 6 to day 12 to analyse NH₄⁺—N, NO₂⁻—N, and NO₃⁻—N concentrations. All experiments were conducted in triplicate.

Determination of NO₃⁻, NO₂⁻ and NH₄⁺ in the Anammox Test

Concentrations of NH₄⁺—N, NO₂⁻—N, and NO₃⁻—N were determined using Hach TNT® test kits 832, 840, and 835, respectively, and measured with a DR 3900 spectrophotometer (Hach, Loveland, CO, USA). Prior to analysis, samples were filtered through 0.45 μm syringe filters (Millipore Sigma, MD, USA). The VSS concentrations were measured in accordance with Standard Methods⁴⁸. RStudio was used to conduct statistical analysis, such as ANOVA and t-tests, to determine whether the differences between three or two groups of variables were statistically significant, with 95% confidence intervals (p<0.05).

### TEA and LCA Methods

The TEA and LCA builds upon the Environmental Protection Agency's report for wastewater treatment, and the electrochemical cost framework developed by the Department of Energy and expanded by Orella et al. The TEA/LCA analysis models the NdN, PdNA, and ePdNA scenarios at a 10 million gallons per day of wastewater treatment capacity. The TEA estimates the annualized operating costs, and the LCA calculates the cradle-to-gate environmental impact. The LCA employs the U.S. TRACI methodology implemented in OpenLCA with the EcoInvent v3.71 database. The key TEA/LCA metrics are costs and global warming potential (GWP) per m³ of wastewater.

### Techno-Economic Analysis (TEA) Method

The TEA evaluates the tertiary polishing step of a 37.6-million-m³·y⁻¹ municipal facility that receives secondary effluent containing 20 mg-N·L⁻¹ and targets a 7 mg-N·L⁻¹ residual. The functional unit is 1 m³ of treated wastewater, consistent with the EPA reference data. The electrochemical stack is sized to supply the stoichiometric nitrite and ammonia required by anammox, eliminating exogenous methanol. The balance of plant (BOP) and biological stages are parameterized from the EPA data set and mass-balance spreadsheets.

Electrochemical Performance Calculations: Faradaic efficiencies for nitrite (FEₚ=0.45), ammonia (FEₐ=0.45 enforced for a 1:1 ratio), and hydrogen (FEₕ=0.10 floor) follow typical measurements. The model computes current, reactor area, voltage losses, and throughput directly from design variables:

$$i = - \frac{{\dot{n}}_{{NO}_{2}^{-}} {n}_{e} F}{{FE}_{p}} , A = \frac{\vert i \vert}{\vert j \vert}$$

$${V}_{cell} = {E}^{0} + \frac{RT}{{n}_{e} F} ln ( \frac{1 - X}{X {FE}_{p}} ) + {η}_{kin} + {η}_{ohm} + {η}_{mt}$$

$${η}_{ohm} = \frac{\vert j \vert g}{σ \times {10}^{4}} , {η}_{mt} = \frac{RT}{{n}_{e} F} ln ( 1 - \frac{j}{{j}_{lim}} )$$

where (X) is the nitrate conversion (0.65), (g) is the 0.18-cm gap, (σ=0.08-1), jₗᵢₘ is evaluated from the 1.7×10⁻⁹ m²·s⁻¹ diffusion coefficient, and ηₖᵢₙ is obtained from the Butler-Volmer root solved in the Wolfram notebook. Flow and mass balances yield nitric oxide reduction demand, wastewater throughput, and by-product hydrogen flow, ensuring the ammonium:nitrite molar ratio remains 1.0 for downstream anammox.

Electrochemical System Costing Formulation: Direct costs include electricity (0.046 $ kWh⁻¹ industrial tariff), nitrate feed (5.7×10⁻⁴ $·kg⁻¹), solvent (~0.001 $·kg⁻¹), KCl supporting electrolyte (0.40 $ kg⁻¹), and cathode catalyst (15 $·kg⁻¹ with a 1 g m⁻² loading). Capital costs scale with area using H2A-inspired coefficients:

$${C}_{cell} = A [ exp ( ln {b}_{p} + {s}_{a} ln \frac{{\dot{n}}_{prod}}{{\dot{n}}_{base}} ) + {m}_{cat} {c}_{cat} ]$$

$${C}_{BOP} = A exp ( ln {b}_{BOP} + {s}_{b} ln \frac{{\dot{n}}_{prod}}{{\dot{n}}_{base}} )$$

with bₚ=1.06× 10⁴ $·m⁻², sₐ=0.0268, b_{BOP}=1.53× 10⁴ $·m⁻², and s_{b}=−0.0432. A simple-depreciation lifetime of 2.5 stack-years (300 operating days·y⁻¹) is assumed for both stack and BOP elements. Separation costs are negligible at the current purity assumptions (kp=0). Operating expenses are normalized by the treated wastewater flow, and a 14% overhead factor covers insurance, permitting, and contingencies:

$${C}_{unit} = \frac{{C}_{elec} + {C}_{electrolyte} + {C}_{cell} + {C}_{BOP} + {C}_{sep}}{( 1 - {f}_{overhead} ) {\dot{V}}_{WW}}$$

Coupling with Anammox and Conventional Processes: The TEA couples the electrolyzer with an anammox reactor whose capital cost and labor requirements are drawn from our previous study. The analysis compares three cases:
1. Conventional: 5-stage Bardenpho with denitrification filter.
2. Bio-PdNA: Biologically driven partial denitrification-anammox process.
3. AO-PdNA-ElecChem: Bio-PdNA followed by the electrochemical nitrite generator.

### Life-Cycle Assessment (LCA) Methods

Functional Unit and Boundary: The LCA shares the TEA functional unit (1 m³ of secondary effluent polished to 7 mg-N·L⁻¹) and includes screening, grit removal, primary clarification, 5-stage BNR, denitrification filters, anaerobic digestion, sludge hauling/landfilling, and the electrochemical reactor when applicable. Infrastructure materials (earthwork, concrete, steel, filter media) and transportation are included. The LCA consists of a gate-to-gate analysis. The wastewater influent arrives at the facility as a waste stream. In this analysis, we assume a zero-burden assumption consistent with the EPA analysis. Zero-burden means that the environmental impacts associated with the stream are allocated to the upstream activities that generated the stream. This is a common assumption for waste treatment systems, which avoid disposal or other end-of-life scenarios. The wastewater is treated within the facility using one of the three systems considered in this study. The facility employs electricity from the US grid for aeration, electrochemical synthesis, and other power demands. Methanol is the main purchased chemical. Cleaned water, sludge, biogas, N₂O, CH₄ are the main outputs. The allocation of impacts is based on the system expansion method. In these scenarios, there are no products sold to the market; thus, all emissions are counted toward the footprint of the wastewater stream.

Inventory Assembly: The EPA Level 4 and 5 workbooks supply per-m³ consumption of electricity, natural gas, reagents, transport, infrastructure, and fugitive gases.

Impact Assessment: Resource flows are multiplied by the impact factors gathered from the EcoInvent v 3.7 database, which corresponds to TRACI midpoint categories. For a given category (c),

$${I}_{c} = {\sum }_{j} {A}_{j} \times {EF}_{j , c} ,$$

where (Aⱼ) is the annualized activity (e.g., kWh of grid electricity per m³) and (_{j.c}) is the per-unit emission factor (e.g., 0.142 kg-CO₂-eq·kWh⁻¹). Outputs are grouped by major processes (BNR, electrochemical reactor, anaerobic digester, sludge handling, other infrastructure) and by resource drivers (electricity, natural gas, methane, nitrous oxide, other) following the convention in the EPA report.

Key Assumptions and Data Sources: Table 1 shows the key parameters and values assumed in the baseline analysis. These assumptions are primarily based on the EPA report, and the electrochemical frameworks by the Department of Energy (DOE) and Orella et al.

TABLE 1
BASELINE PARAMETERS AND VALUES FOR INTEGRATED
ANAMMOX-ELECTROCHEMICAL WASTEWATER TREATMENT

| Parameter | Value | Source/Notes |
|---|---|---|
| Wastewater flow | 5,220 m³ · h⁻¹ (37.6M m³ · y⁻¹) | 10 million gallons per day |
| Influent/effluent TN | 20 → 7 mg-N · L⁻¹ | EPA design basis |
| Electrochemical operating days | 300 d · y⁻¹ | |
| Current density (j) | −900 A · m⁻² | |
| Faradaic efficiencies | FEₚ = 0.45 (NO₂⁻), FEₐ = 0.45 | Enforced 1:1 NO₂⁻:NH₄⁺ |
| | (NH₃), FEₕ ≥ 0.10 | |
| Cell gap/conductivity | 0.18 cm/0.08 S · cm⁻¹ | Nafion 117 estimate |
| Electricity tariff | 0.046 $ · kWh⁻¹ | US Industrial average |
| Methanol unit price | 0.60 $ · kg⁻¹ | EPA design basis |
| Methanol requirement | 5 kg-MeOH · kg-NO₃⁻¹ at | |
| | denitrification extent 0.26 | |
| Silver loading/price | 1 g · m⁻²/15 $ · kg⁻¹ | Catalyst quotation |
| Aeration, carbon, sludge savings | 0.12/0.18/0.08 $ · kg-N⁻¹ | EPA design basis |
| Polymer reduction | 20% | |
| (electrochemical case) | | |
| LCI impact factors | TRACI-based | EcoInvent v 7.3 |

Table 1 lists the lifecycle inventory impact factors gathered from the EcoInvent v 7.3 database. Most processes were selected based on the EPA wastewater treatment report. Some processes were updated to reflect versions available in the latest EcoInvent database.

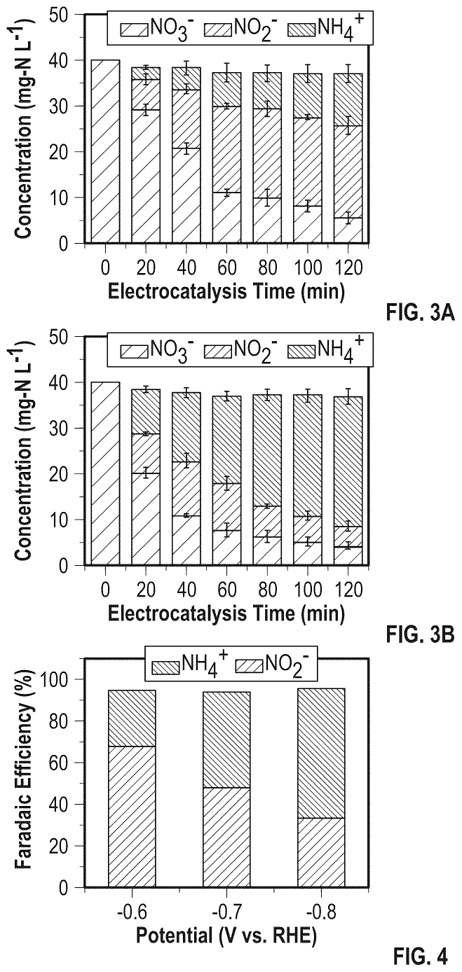

FIGS. 3A and 3B are graphs that depicts the electrocatalytic performance of Cu NWs in simulated wastewater. FIG. 3A depicts NO₃⁻, NO₂⁻, and NH₄⁺ concentrations in simulated wastewater (40 mg-N L⁻¹ NO₃⁻ in PBS) at −0.6 V (V vs. RHE) over different electrolysis durations. FIG. 3B depicts NO₃⁻, NO₂⁻, and NH₄⁺ concentrations in simulated wastewater (40 mg-NL⁻¹ NO₃⁻ in PBS) at −0.8 V (V vs. RHE) over different electrolysis durations.

FIG. 4 is a graph that depicts electrocatalytic performance of Cu NWs in simulated wastewater. It depicts Faradaic efficiency of Cu NWs for NO₂⁻ and NH₄⁺ in simulated wastewater (40 mg-N L⁻¹ NO₃⁻; in PBS) at −0.6 V, −0.7 V and −0.8 V (V vs. RHE).

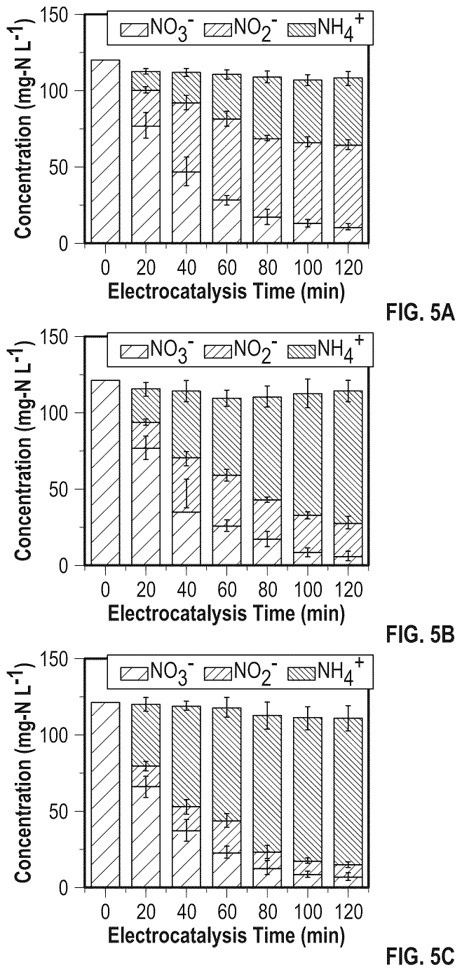

FIGS. 5A, 5B and 5C are graphs that depict electrocatalytic performance of Cu NWs in simulated wastewater. FIG. 5A depicts NO₃⁻, NO₂⁻, and NH₄⁺ concentrations in simulated wastewater (120 mg-N L⁻¹ NO₃⁻ in PBS) at −0.6 V (V vs. RHE) over different electrolysis durations. FIG. 5B depicts NO₃⁻, NO₂⁻, and NH₄⁺ concentrations in simulated wastewater (120 mg-NL⁻¹ NO₃⁻ in PBS) at −0.7 V (V vs. RHE) over different electrolysis durations. FIG. 5C depicts NO₃⁻, NO₂⁻, and NH₄⁺ concentrations in simulated wastewater (120 mg-N L⁻¹ NO₃⁻; in PBS) at −0.8 V (V vs. RHE) over different electrolysis durations.

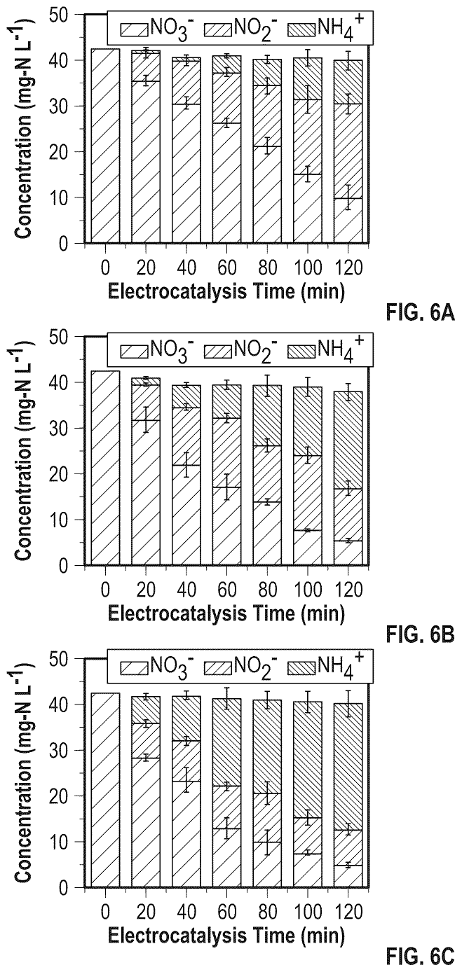

FIGS. 6A, 6B and 6C are graphs that depict electrocatalytic performance of Cu NWs in simulated wastewater. FIG. 6A depicts NO₃⁻, NO₂⁻, and NH₄⁺ concentrations in simulated wastewater (40 mg-N L⁻¹ NO₃⁻ in 0.1 M KOH) at −0.2 V (V vs. RHE) over different electrolysis durations. FIG. 6B depicts NO₃⁻, NO₂⁻, and NH₄⁺ concentrations in simulated wastewater (40 mg-NL⁻¹ NO₃⁻ in 0.1 M KOH) at −0.3 V (V vs. RHE) over different electrolysis durations. FIG. 6C depicts NO₃⁻, NO₂⁻, and NH₄⁺ concentrations in simulated wastewater (40 mg-NL⁻¹ NO₃⁻; in 0.1 M KOH) at −0.4 V (V vs. RHE) over different electrolysis durations.

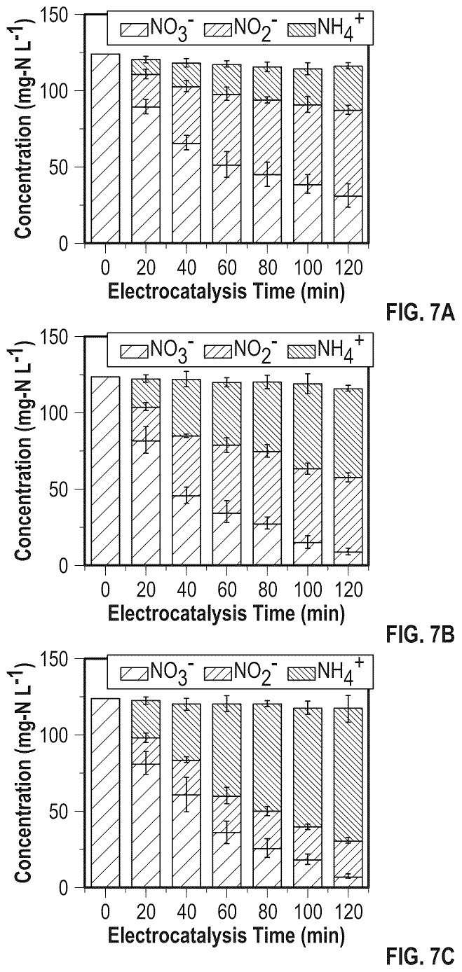

FIGS. 7A, 7B and 7C are graphs that depict electrocatalytic performance of Cu NWs in simulated wastewater. FIG. 7A depicts NO₃⁻, NO₂⁻, and NH₄⁺ concentrations in simulated wastewater (120 mg-N L⁻¹ NO₃⁻ in 0.1 M KOH) at −0.2 V (V vs. RHE) under different electrolysis durations. FIG. 7B depicts NO₃⁻, NO₂⁻, and NH₄⁺ concentrations in simulated wastewater (120 mg-NL⁻¹ NO₃⁻ in 0.1 M KOH) at −0.3 V (V vs. RHE) under different electrolysis durations. FIG. 7C depicts NO₃⁻, NO₂⁻, and NH₄⁺ concentrations in simulated wastewater (120 mg-N L⁻¹ NO₃⁻; in 0.1 M KOH) at −0.4 V (V vs. RHE) under different electrolysis durations.

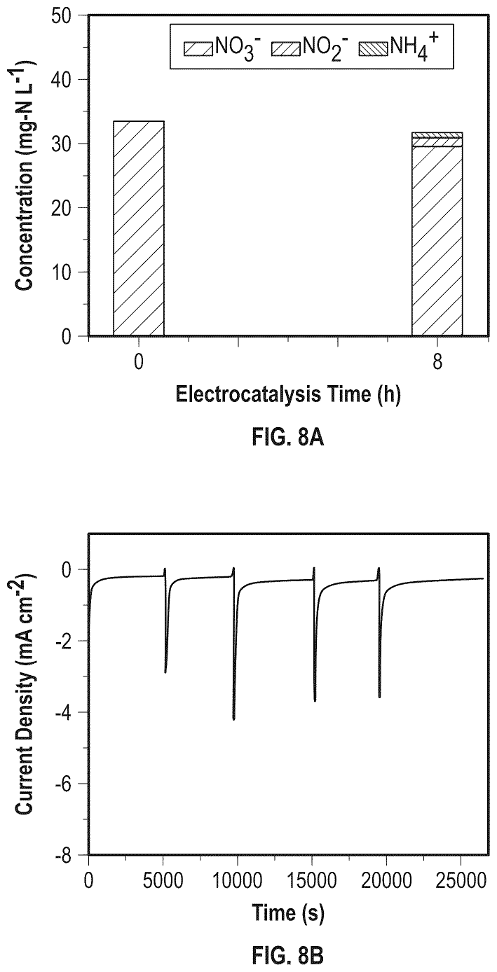

FIGS. 8A and 8B are graphs that depict electrocatalytic performance of Cu NWs in municipal wastewater. FIG. 8A depicts NO₃⁻, NO₂⁻, and NH₄⁺ concentrations in municipal wastewater at −0.6 V (V vs. RHE) under different electrolysis durations. FIG. 8B depicts time-current curves of Cu NWs at −0.6 V (V vs. RHE) over five consecutive cycles with fresh electrodes in municipal wastewater.

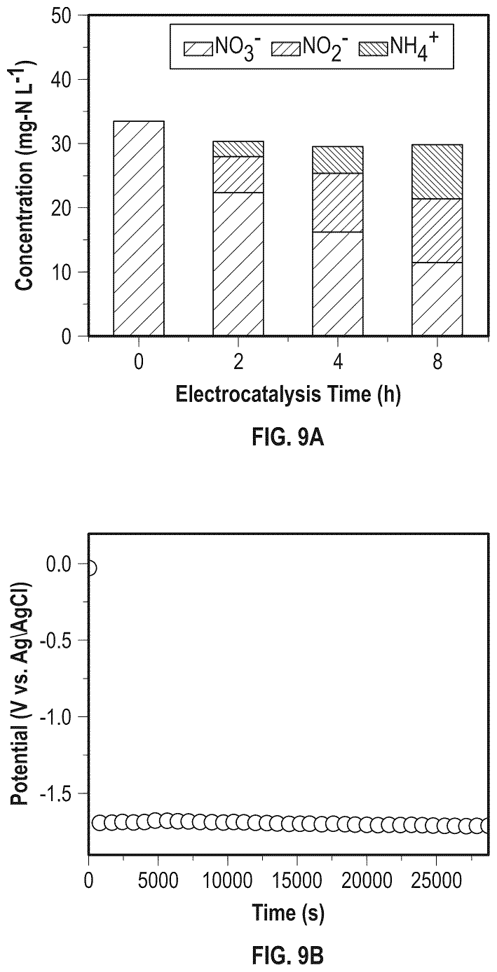

FIGS. 9A and 9B are graphs that depict electrocatalytic performance of Cu NWs in municipal wastewater. FIG. 9A depicts NO₃⁻, NO₂⁻, and NH₄⁺ concentrations in municipal wastewater at −10 mA cm⁻² over different electrolysis durations. FIG. 9B depicts time-potential curves of Bi NPs at −10 mA cm⁻² in municipal wastewater.

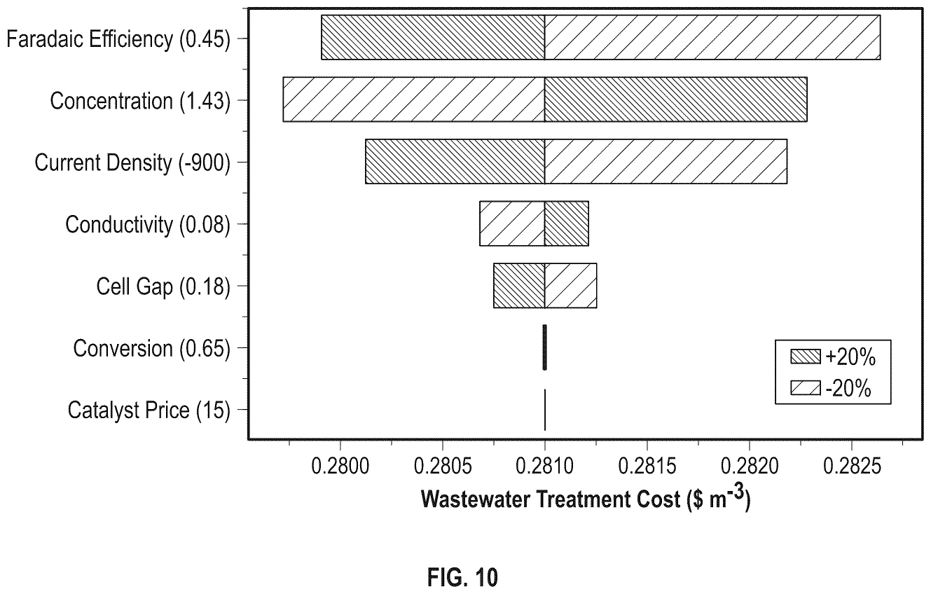

FIG. 10 is a graph that depicts economic sensitivity analysis of an ePdNA wastewater treatment process. Baseline scenario values: Faradaic efficiency is 45%, the initial contaminant concentration is 1.43 mol m⁻³, the current density is −900 A m⁻², the electrolyte conductivity is 0.08 S cm⁻¹, the electrode cell gap is 0.18 cm, the single-pass conversion is 0.65, and the catalyst price is 15 USD kg⁻¹.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

In the drawings, not all reference numbers are included in each drawing, for the sake of clarity. In addition, positional terms such as “upper,” “lower,” “side,” “top,” “bottom,” etc. refer to the apparatus when in the orientation shown in the drawing. A person of skill in the art will recognize that the apparatus can assume different orientations when in use.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A wastewater treatment system, comprising:
(i) a biological treatment train comprising an anaerobic zone, a first oxic zone downstream of the anaerobic zone, and a secondary clarifier downstream of the first oxic zone, the secondary clarifier being configured to separate a mixed liquor into a clarified effluent and a settled biomass; and
(ii) an integrated electrochemical-biological cascade disposed downstream of the secondary clarifier, the cascade comprising an electrochemical module configured to receive at least a portion of the clarified effluent and electrochemically reduce nitrate (NO₃⁻) in the clarified effluent to a mixture comprising nitrite (NO₂⁻) and ammonium (NH₄⁺) in controlled proportions; and
an anammox module downstream of the electrochemical module and configured to convert, under anoxic conditions, at least a portion of the nitrite and ammonium to nitrogen gas (N₂).

2. The system of claim 1, wherein the cascade further comprises a second oxic zone disposed downstream of the anammox module and configured as a polishing and stabilization stage for treated wastewater.

3. The system of claim 1, wherein the electrochemical module comprises an electrolysis cell including an anode and a cathode that are energized to induce controlled electrochemical reactions in the clarified effluent.

4. The system of claim 3, wherein the electrolysis cell is a divided cell including a membrane positioned between the anode and the cathode, the membrane comprising a cation-exchange membrane, an anion-exchange membrane, or a bipolar membrane.

5. The system of claim 3, wherein the electrolysis cell is an undivided cell.

6. The system of claim 3, wherein the cathode comprises metal nanowires supported on a conductive porous substrate.

7. The system of claim 6, wherein the conductive porous substrate comprises carbon paper, carbon cloth, graphite felt, carbon aerogel, carbon nanotubes, metal mesh, or a combination thereof.

8. The system of claim 6, wherein the metal nanowires have an average diameter of from about 10 nm to about 100 nm and an average length of greater than about 1 μm.

9. The system of claim 6, wherein the metal nanowires comprise copper nanowires.

10. The system of claim 3, wherein the cathode comprises a catalyst comprising bismuth nanoparticles.

11. The system of claim 1, wherein the electrochemical module is operated under potentiostatic control relative to a reference electrode, and wherein an applied potential is selected within a first potential range that favors formation of nitrite and within a second, more cathodic potential range that increases formation of ammonium.

12. The system of claim 1, wherein the electrochemical module is operated with a time-varying electrical input comprising a pulsed waveform including alternating cathodic pulses and anodic pulses, wherein a cathodic pulse drives nitrate reduction and an anodic pulse reconstructs or regenerates a catalytic surface to mitigate fouling, catalyst poisoning, scaling, or passivation.

13. The system of claim 1, further comprising a controller operatively coupled to the electrochemical module and configured to adjust at least one operating variable to maintain a target nitrite-to-ammonium ratio in an effluent of the electrochemical module.

14. The system of claim 13, wherein the at least one operating variable comprises applied potential, current density, duty cycle, pulse frequency, waveform parameters, residence time within the electrochemical module, flow rate, pH, alkalinity, electrolyte conductivity, or a periodic regeneration step.

15. The system of claim 1, further comprising at least one sensor configured to measure at least one parameter selected from nitrate, nitrite, ammonium, pH, oxidation-reduction potential (ORP), conductivity, and current, wherein the controller is configured to adjust operation of the electrochemical module based at least in part on an output of the at least one sensor.

16. The system of claim 1, wherein the anammox module comprises a suspended-growth reactor, an attached-growth reactor, a granular sludge reactor, a moving bed biofilm reactor (MBBR), an integrated fixed-film activated sludge (IFAS) reactor, or a combination thereof.

17. The system of claim 1, wherein the anammox module is configured to receive a feed having a nitrite-nitrogen to ammonium-nitrogen ratio of about 1:1 on a nitrogen basis, optionally within ±20%.

18. A method of treating wastewater, comprising:
conveying a clarified effluent from a secondary clarifier to an electrochemical module;
electrochemically reducing nitrate in the clarified effluent within the electrochemical module to form nitrite and ammonium in controlled proportions;
conveying an effluent of the electrochemical module comprising the nitrite and ammonium to an anammox module; and
converting, under anoxic conditions in the anammox module, at least a portion of the nitrite and ammonium to nitrogen gas.

19. The method of claim 18, further comprising operating the electrochemical module with a pulsed waveform comprising alternating cathodic pulses and anodic pulses, and adjusting at least one of applied potential, current density, duty cycle, pulse frequency, residence time, flow rate, pH, or electrolyte conductivity to maintain a target nitrite-to-ammonium ratio.

20. A method of manufacturing an electrochemical electrode for wastewater nitrate reduction, comprising:
depositing a metal nanowire catalyst onto a conductive porous substrate to form a cathode, wherein the metal nanowire catalyst comprises copper nanowires having an average diameter of from about 10 nm to about 100 nm and an average length of greater than about 1 μm; and
assembling the cathode into an electrolysis cell of an electrochemical module configured to partially reduce nitrate in clarified wastewater to a mixture comprising nitrite and ammonium.
